(19) United States
(12) Patent Application Publication
(10) Pub. No.: US 2010/0104283 A1
(43) Pub. Date: Apr. 29, 2010

(54) TECHNIQUE FOR MANAGING OPTICAL NETWORKS

(75) Inventor: Uri Mahlab, Or Yehuda (IL)

Correspondence Address: BROWDY AND NEIMARK, P.L.L.C.;624 NINTH STREET, NW, SUITE 300, WASHINGTON, DC, 20001-5303, US

(73) Assignee: ECI TELECOM LTD, Petach-Tikva (IL)

(21) Appl. No.: 12/524,670

(22) PCT Filed: Jan. 1, 2008
(86) PCT No.: PCT/IL08/00001

§ 371 Date: Jul. 27, 2009

(30) Foreign Application Priority Data
Feb. 1, 2007 (IL) 181135

(51) Int. Cl. H04J 14/00

(52) U.S. Cl. 398/58

(57) ABSTRACT

For securing from invasion a group of network nodes in a multi-channel optical communication network, providing wavelength selective optical amplifiers WSOA in optical fiber links incoming network nodes of the group, and providing a network controller NC for holding and updating control information about optical channels allowed in specific optical fiber links incoming specific network nodes of the group, and for supplying each of the WSOAs with suitable control information concerning the incoming optical fiber links associated therewith. At each specific WSOA, in response to the received control information, blocking any incoming wavelength except for wavelengths assigned to the optical channels allowed in that specific incoming optical fiber link.

### FIELD OF THE INVENTION

The invention relates to techniques for managing modern optical networks and their elements, for example for securing from invasion.

### BACKGROUND OF THE INVENTION

Modern optical networks comprise a great number of network elements interconnected by optical fiber links into various configurations, the most popular ones being a point-to-point configuration, a ring-like configuration and a mesh configuration. The optical fiber links of modern optical networks are normally capable of conveying a plurality of optical channels using a plurality of specified different optical wavelengths. Optical fiber links of existing optical networks can be considered as practically open optical conduits, since no protection presently exists against a potential intruder/attacker. The attacker may succeed to introduce into the network a pirate (foreign, malicious) optical signal using any optical wavelength principally transmittable via the fiber links. Such a pirate signal, if having a considerable power and/or amplified by a number of amplifiers along its transmission path in the network, may easily destroy operation of the network.

Several patents relevant to the invention have been uncovered.

U.S. Pat. No. 6,374,019 describes a multi-wavelength selective switch utilizing wavelength selective optical amplifiers, such as current controlled distributed Bragg-reflector (DBR) amplifiers or quarter-wavelength chirping amplifiers in order to differentially amplify the wavelength division multiplexed signals in different waveguides of the switch, for equalizing power of different wavelengths signals (in case a signal of a specific wavelength is divided between some waveguides). A number of required wavelength selective optical amplifiers in each waveguide of the U.S. Pat. No. 6,374,019 is preferably the same as the number of wavelengths, and therefore each of such amplifiers is actually controlled to perform the required amplification of a specific selected wavelength. The mentioned amplifiers are utilized for selectively compensating intensity of light in different waveguides.

US2003016431A (to CoAdna Photonics) describes an apparatus for processing an optical beam, which has at least one variable optical element to dynamically alter the polarization state of a polarized optical beam to form a polarization-altered optical beam. A polarization analyzer is operative, in conjunction with at least one variable optical element and wave plate to alter the transmitted amplitude of the polarization-altered is optical beam as a function of wavelength, and thereby produce an output optical beam with transmitted amplitude adjusted as a function of wavelength. The apparatus is a passive optical fiber and does not comprise amplifiers.

JP2006243571A2 (to Fujitsu) describes a small and inexpensive wavelength selective switch WSS capable of accurately monitoring the power of each wavelength channel guided to a plurality of output ports. This WSS separates WDM light emitted from the input fiber of a fiber collimator array with a diffraction grating in accordance with wavelengths, and reflects each wavelength channel radiating in different directions with corresponding MEMS mirrors of a mirror array. Each MEMS mirror is set in the angle of the reflection area correspondingly to the position of output ports that are set in the output side of the incident wavelength channel. Each wavelength channel reaching the target output port is each partly reflected on the end face of the output fiber, with the reflected light returned to the input port and sent to a channel monitor through an optical circulator. Consequently, the optical power corresponding to each wavelength channel is monitored. No amplification is proposed for it.

### OBJECT AND SUMMARY OF THE INVENTION

It is the object of the present invention to provide a technique for managing optical networks and their nodes, preferably for securing from invasion performed by outside attackers.

To the best of the Applicant's knowledge, none of the prior art references presents a network solution (a method or a configuration) suitable for preventing or overcoming attacks on an optical communication network.

Similarly, none of the prior art references arrives to designing a controllable piece of optical network equipment simultaneously possessing and combining both its conventional regular function required for optical communication networks and a novel feature allowing the use of such a piece for flexible managing optical networks and in particular—for securing the network traffic from invasion.

The above object can be achieved by providing a) a method for managing an optical network, especially in cases of intruders' attacks, b) the optical network or part of such a network, adapted to be controlled and protected against various artifacts or attacks, and c) a new type of network equipment reconfigurable so as to allow operation in the network/at a specific network section only at such wavelengths which are allowed in the network or in a specific network section respectively.

According to a first aspect of the invention, there is provided a method for managing a group of network nodes in a multi-channel optical communication network comprising a plurality of network nodes and a number of optical fiber links, wherein the group comprises at least one network node,

the method comprising:

per each specific node of said group, providing one or more wavelength selective optical amplifiers WSOA respectively connected between said specific network node and one or more optical fiber links incoming said specific network node;

providing a network controller NC adapted to hold and update control information about optical channels allowed in said one or more optical fiber links incoming the network nodes of the group, and to supply each of said wavelength selective amplifiers WSOA with suitable control information concerning the incoming optical fiber link associated therewith;

at each of said wavelength selective amplifiers WSOA, in response to the control information received from the NC, blocking any incoming wavelength except for wavelengths assigned to the optical channels allowed in the optical fiber link incoming said WSOA.

The method is advantageous for securing/protecting network nodes and networks against invasion. The invasion (or attack) is to be understood as a non-authorized insertion into the network of one or more optical signals using one or more optical wavelengths transmittable via the optical fiber links of the network.

An allowed or working optical channel is to be understood as an optical channel expected (pre-provisioned say by a network-designer for a specific network) at a particular optical fiber link in the network.

The wavelengths which are blocked at the WSOAs can be considered non-allowed by the NC; they are usually so-called spare (non-active, non-working) wavelengths which are not assigned to the optical channels allowed in the optical fiber links incoming the network nodes of the group.

The network may be a ring-like network, a point-to point network, a mesh-like network or a mixed type network.

The network nodes are preferably selected from a collection comprising optical or optical/electrical elements being adapted to perform to various functions such as: compensating, amplifying, switching, restoring, performing wavelength conversion of incoming optical signals, etc.

Preferably, the method comprises additional steps, which can be used for detecting an invasion:
determining whether one or more of the wavelengths blocked by any of said WSOA carry optical signals, for example foreign (non-expected, undesired) signals,
if in the affirmative, issuing an indication signal to the network controller NC, informing about the one or more of the blocked wavelengths where said signals have been determined.

The detection of optical signals in the blocked optic channels can be performed by power detection and further comparison of the detected power level with a selected reference. For example, a power level detected in one blocked optic channel can be compared either with a predetermined threshold or with a power level detected in at least one other blocked optic channel.

In s specific case, the method may further comprise making a decision that an attack has been undertaken via said one or more of the blocked wavelengths, and initiating one or more security measures.

Such a decision can be made at the NC, and the NC can initiate the security measures; said measures may for example comprise:
wavelength conversion of a working channel (can be performed, for example, when an attacked channel is spectrally adjacent to a working channel and may therefore affect it);
selecting an alternative path in the network to avoid possible damage to the working traffic by the attacked channel(s).

However, it may happen that any of the allowed (working) channels is attacked by an intruder, or carry any non-typical or degraded signal.

To detect and overcome such a situation, the method further comprises a step of analyzing optical signals carried by one or more of the allowed (working) channels, and possibly comprises taking security measures whenever an attack of any working optical channel is detected.

To perform the analyzing function, the method may comprise a step of providing one or more channel monitoring units for monitoring optical signals at least in one or more of said allowed optic channels, each of the channel monitors being capable of producing an alarm signal in case an optical signal transmitted in a specific allowed optic channel does not satisfy one or more predetermined criteria. The criteria are preferably predetermined threshold values of Quality Of Service (QOS), such as a Bit Error Rate (BER) threshold value or the like.

The alarm signal is preferably reported to the network controller NC, where a decision is to be made and suitable security measures are supposed to be taken if the NC determines an attack.

Optionally, the method may comprise providing one or more local controllers LC, preferably and respectively associated with one or more of said WSOAs and adapted to collect alarm signals from said respective channel monitoring units. The local controller LC should be adapted to take immediate security measures at the place where a problem/an attack is detected. Namely, in case the alarm signal is received with respect to a particular working channel in a specific incoming fiber optic link, the LC will be adapted to issue a local control signal to the associated WSOA to block said particular working channel.

The alarm signal can thus be reported either to the network controller NC, or to the local controller LC if provided at the optical fiber link where the attack is detected, or to both.

At least the following security measures can be taken when invasion (attack) is determined to take place in a working channel:
a) applying updated control signals to at least one of the WSOAs, thereby causing blocking of the attacked working channel by said at least one WSOA; this measure can be performed both locally by the local controller LC, and centrally by the network controller NC;
b) performing a wavelength conversion operation with respect to the attacked working channel, by transmitting traffic of the attacked working channel over a spare optic channel (spare carrier wavelength), which will become allowed; this measure can preferably be performed with the aid of the NC;
c) rerouting traffic of the attacked working channel via other sections of the network, not subjected to the attack; such a measure may only be performed by the NC.

According to a second aspect of the invention, there is provided a network section in a multi-channel optical network comprising a plurality of network nodes and a number of optical fiber links, the network section comprising:

a group of one or more network nodes wherein, at each specific network node of the group, at least one optical fiber link incoming the specific network node is provided with at least one wavelength selective optical amplifier WSOA,

a network controller NC adapted to hold and update control information about optical channels allowed in said at least one optical fiber link incoming said at least one network node of the group, and to provide each of said at least one wavelength selective amplifier WSOA with suitable control information concerning the optic fiber link associated therewith;

wherein each of said at least one WSOA is adapted to be controlled by said network controller NC so as to amplify only wavelengths assigned to the optical channels allowed in the optic fiber link associated with said WSOA, while blocking any other wavelengths.

Such a network section (and each node of the section) becomes secured against any excessive, undesired, malicious or foreign signals which may be present/be inserted in the network, and prevents non-desired amplifying and forwarding such signals to the optical network.

An optical fiber link incoming a network node is to be understood as an optical communication link intended for transmitting traffic incoming said network node.

Preferably, the proposed security arrangement is most applicable to those network sections which are maximally subjected to outside attacks: for example, comprising long optical paths passing via territories where inspection can hardly be performed and thus intrusion may not be excluded, and/or comprising network node(s) which are connected to external network(s) via which malicious signals may penetrate into our optical network.

According to one specific embodiment, said secured network section may constitute (cover) the whole said optical network; according to another specific embodiment, the secured network section may comprise a single network node, preferably a border node between two networks.

In one embodiment of the network, the network controller NC forms part of a centralized network management System NMS and holds topology data on at least said network section and, according to said topology data,
a) considers working optical channels expected/provisioned to pass via a specific optical fiber link to be allowed optical channels for that specific optical fiber link;
b) provides control of the WSOAs in the network section according to the topology data, by issuing respective control signals.
   In other words, NC considers working channels expected to enter a specific network node via an incoming optical fiber link as allowed channels at said incoming optical fiber link. Other channels, though principally transmittable via said optical fiber link but not expected at the specific network node, are considered not allowed and thus, in response to a control signal from the network controller NC, are to be blocked by the WSOA connected between said incoming optical link and the specific network node.

The network section may be further adapted to determine, whether an optical (possibly, foreign) signal exists in any of the wavelengths blocked by said at least one WSOAs, and if in the affirmative, to provide a suitable indication signal to the network controller NC. For example, a number of per-channel power detectors can be provided in association with at least one of said WSOAs, capable of determining power of signals at the blocked wavelengths, and issuing the indication signal when the determined power is somewhat suspicious.

The network controller NC may be further capable of detecting an attack in the network section in response to the indication signal received from said power detectors, and initiating corresponding security measures to minimize damages of the attack.

The network section may be further provided with at least one monitoring unit (monitor) associated with any optical fiber link of the network section for monitoring optical channels (preferably one or more of the optical channels allowed in said link) and being capable of issuing an alarm signal if an abnormal situation is detected in one or more of said allowed (working) optic channels. The monitor may be located at any optical fiber link of the section, and at any portion of the optic fiber link. If the link comprises a WSOA (i.e. the link is an incoming link of one of the network section nodes), the location of the monitoring unit would preferably be after the WSOA or at the network node receiving traffic from said link.

Such a monitoring unit may, for example, be implemented by accommodating one or more conventional blocks for determining at least one of the following parameters of an optical signal: BER (bit error rate), optical signal-to noise ratio (OSNR), any combined parameter. The abnormal situation should therefore be stated if the measured BER is higher than a predetermined maximal BER value, and/or the measured OSNR value is lower than a preliminarily accepted minimal OSNR value.

The channel monitors associated with a specific optical fiber link may be selectively enabled for monitoring particular optical channels (for example, for monitoring only the allowed channels, by means of the same control signal from NC, used for controlling the respective WSOA).

As has been mentioned with respect to the method, the alarm signals may be reported to the network controller NC for making decisions and taking possible security measures. In this case, the NC should be adapted to collect alarm signals from the working channels monitors and process thereof accordingly (for example, to issue updated control signals to said WSOAs for blocking one or more previously allowed working channels, to perform wavelength conversion, to execute rerouting, etc.)

However, the network section may be provided with at least one local controller LC associated with a WSOA and capable of receiving and immediately processing the alarm signals whenever received with respect to the local optical fiber link connected to the WSOA. The LC may then be adapted to urgently order blocking of the attacked working channel within said WSOA.

Preferably, the LC is in informational and control communication with the NC.

Additionally, as a third aspect of the invention, there is provided a wavelength selective optical amplifier (WSOA) controllable by a control signal and intended to be connected, as an integrated component, in an optical fiber link (for example, a link incoming a network node of a multi-channel optical network, such as a wavelength division multiplexed (WDM) optical communication network),

the WSOA being adapted, when switched in the optical fiber link and controlled by the control signal, to selectively block narrow bands of one or more optical wavelengths among various optical wavelengths incoming said WSOA from the optical fiber link, while amplifying non-blocked wavelengths incoming said WSOA.

The proposed controllable WSOA may thereby secure at least a section of the network from invasion (attacks), by preventing undesired optical signals, if carried by said blocked wavelengths, from being amplified and forwarded to the optical network.

The integrated wavelength selective optical amplifier WSOA may comprise one or more components selected from a list including: a wavelength selective blocker, a tunable filter, a wavelength selective switch, a selective attenuation array; the WSOA also comprises one or more amplifying components (EDFA amplifier(s), Raman amplifier(s), etc).

Preferably, the integrated WSOA is further provided with means (such as power detectors) for detecting optical signals if carried by one or more wavelengths blocked by said WSOA. Further preferably, the controllable WSOA is adapted to provide information to an outside control unit about wavelengths where said signals (possibly, foreign signals) were detected.

Further preferably, the integrated WSOA is additionally provided with a monitoring unit for monitoring optical signals, preferably in one or more of the allowed optical channels. The unit preferably comprises channel monitors capable of measuring BER and/or other parameters of optical signals transmitted via various possible optical channels. The channel monitors are preferably arranged so as to selectively monitor the amplified optical channels, and adapted to communicate results of the to monitoring to a control unit (external and/or internal).

Optionally, the channel monitors may be selectively activated (enabled) in response to the same control signal used for controlling the WSOA.

Preferably, the integrated WSOA can be provided with an internal local controller LC which serves a mediator between the integrated WSOA and the NC.

Still preferably, the LC can be adapted:

to collect results of the monitoring from the monitoring unit, based on said results, to determine a fact of invasion and
to produce a local control signal to the WSOA for blocking one or more of the monitored, previously allowed optic channels.

Further preferably, the LC is capable to collect both results of monitoring from the monitoring unit and results of detecting from the detectors, and based on that to check the blocking function of the WSOA.

### BRIEF DESCRIPTION OF THE DRAWINGS

The invention will further be described with reference to the following non-limiting drawings, in which:

FIG. 1 illustrates one example of an optical network section according to the invention.

FIG. 2 illustrates one embodiment of a controllable wavelength selective optical amplifier WSOA according to the invention.

### DETAILED DESCRIPTION OF THE PREFERRED EMBODIMENTS

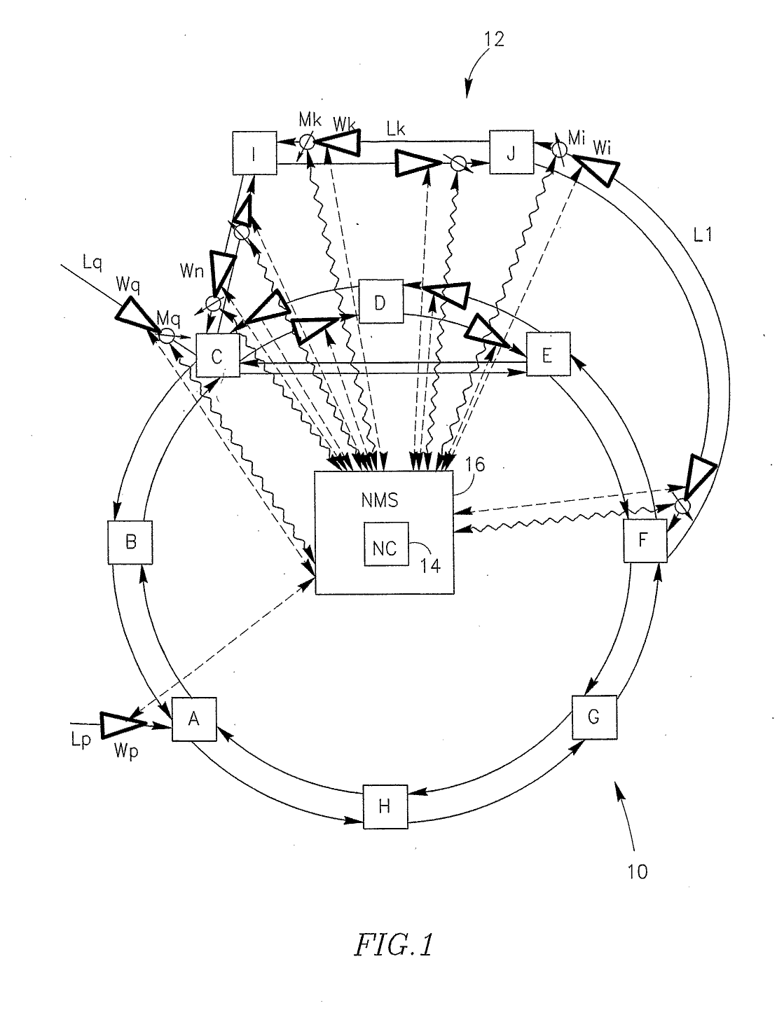

FIG. 1 illustrates one embodiment of a proposed network 10 (being, for example, a combination of a ring-like network and a mesh-like network) where network nodes A, B, . . . H, I, J are connected to one another via optical fiber links L1, L2, . . . Lk, . . . Lq (only some links: L1 Lk, Lp, Lq are marked). The optical fiber links usually include dispersion compensation fibers (DCF), optical filters, amplifiers and other relevant optical components that are used for educated operation of optical networks. Such conventional components are not shown in the drawing. The network 10 comprises a Network controller NC 14 which, in this example, is incorporated in a Network Management System (NMS) 16 of the network 10.

In the proposed network 10, the section being most subjected to intruder attacks is a network section 12 that includes territorially remote nodes C, D E, F, J, I and node A which is connected to an external public network and is therefore subjected to invasion; section 12 also includes fiber optic links associated with the section nodes. The network section 12 is provided with special controllable wavelength selective optical amplifiers WSOAs (W1 . . . Wk . . . Wq), illustrated as conventional triangles. The WSOAs of the network section 12 are respectively connected in the fiber optic links incoming the network nodes of the section.

The network management system NMS 16 holds topologic data about the network 10, which data is continuously or periodically updated. In this specific example, the Network Controller NC 14 is an additional software entity within the NMS, which holds and updates topologic data concerning the “risky” network section 12 and is responsible for performing the method according to the invention with respect to that network section. The topologic data includes information about optical channels (and their associated wavelengths), which should presently be active in the network section 12, and namely—in each fiber optic link of the network section. The NC is in control communication with each of the WSOAs of section 12, and each of the WSOAs is capable to block any wavelength that, according to a control signal received from the NC 14, should not be present in the corresponding specific fiber link served by that WSOA. Different wavelengths may be allowed for different optical fiber links, and control signals issued by the NC to different links might therefore be different.

Additionally, the network section 12 of FIG. 1 is provided with a number of monitoring units for detecting attacks/malfunctions in the allowed (working) optical channels. These monitoring units M (1 . . . k . . . t) are shown as circles. Such monitoring unit can be integrated with the respective WSOAs; alternatively, the monitoring units may be part of the respective nodes, or even be separate self-containing devices positioned before or after the WSOAs. Each of the monitoring units is adapted to check one or more parameters of signal transmission (BER, OSNR, etc) in a particular optical channel; these parameters allow determining non-typical or abnormal processes if taking place in the channel. Such processes (and non-typical, drastic measured parameters: of BER, OSNR or the like) may serve an indication of an attack in the optical channel. Most preferably, each optical channel in the network section 12 should be monitored using such or similar monitoring units, and at least at one point of the channel in the network section. The monitoring units M are illustrated as being in the bi-directional communication with the NC 14/NMS 16 (see the waved lines). The NC 14 may enable operation of specific monitoring units M according to the updated information about allowed channels at specific points of the network. The monitoring units are adapted to report to the NC about non-typical situations if taking place in a specific channel at the specific point of the network. The NC is capable of: collecting the information from the monitoring units, analyzing the information, making decisions whether any of the allowed channels should now be considered non-allowed due to malfunction or intrusion. In case a specific working optical channel is decided to become non-allowed, the NC instructs suitable WSOAs (selected using the topology information) to block the specific optical channel. Alternatively or in addition, the NC is also capable of issuing an instruction for wavelength conversion or re-routing, in order to secure the traffic under attack.

In FIG. 1, the WSOAs of section 12 are also shown in bi-directional communication with the NC. As has been mentioned, each WSOA receives a control signal from the NC 14. Optionally, at least some WSOAs may provide the NC with information about foreign signals if such are detected in the blocked optical channels.

Based on such information, the NC, for example, may decide about performing wavelength conversion of a working optic channel if any attacked blocked channel is spectrally adjacent to that working channel and therefore may affect it. Alternatively, the NC may select an alternative path in the network to avoid possible damage to the traffic in that working channel.

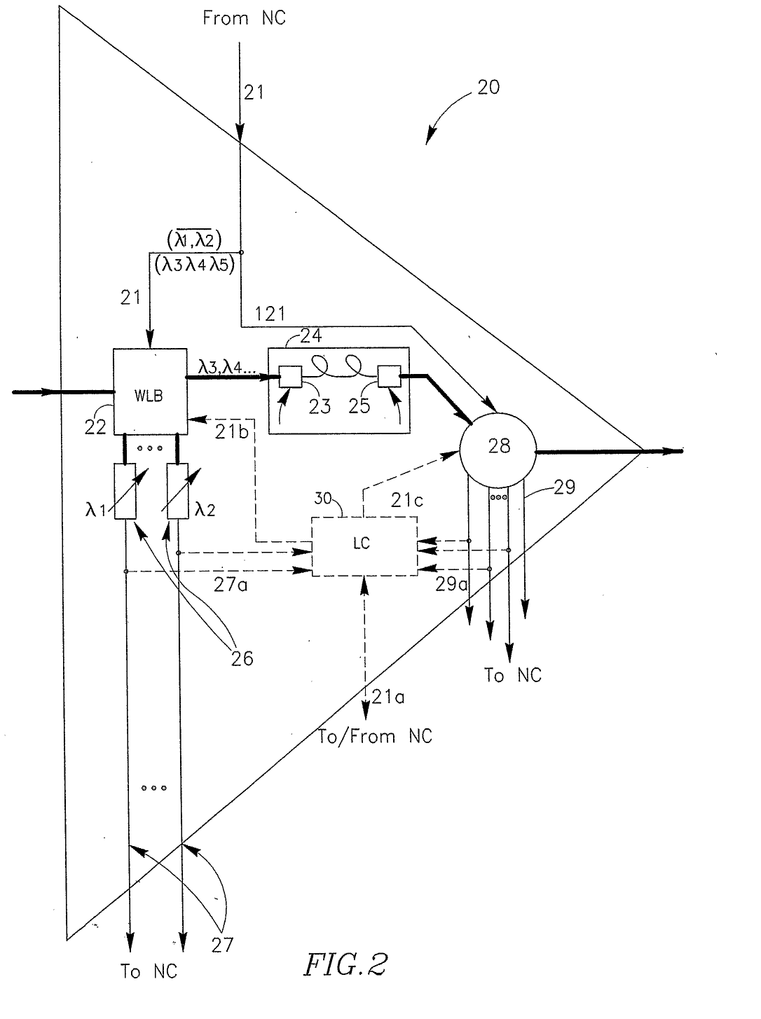

FIG. 2 illustrates an exemplary implementation of an integrated controllable Wavelength Selective Optical Amplifier (WSOA) 20. The amplifier 20 can be used as a network element, capable of performing both its conventional function and an additional function of wavelength selection and blocking selected optical channels (and also attacked optical channels, if and whenever required). Optional capabilities of the WSOA 20 are for analyzing optical signals: a) in the blocked channels, b) in the allowed channels, and a capability of communicating with an external and possibly also internal control entity. The proposed WSOA is both controllable and reconfigurable.

In this specific embodiment, the proposed integrated WSOA comprises a controlled wavelength blocker 22 integrally connected to an EDFA amplifier 24. The illustrated EDFA amplifier 24 comprises an erbium doped fiber EDF provided with a forward optical pump 23 (for example, for a wavelength of 980 nm) and a backward optical pump 25 (for example for a wavelength of 1480 nm). Alternatively, block 22 may be manufactured based on a tunable filter, a wavelength selective switch WSS, a tunable attenuator array combined with DMUX and MUX, and the like.

Let the incoming multiplexed optical signal comprises wavelengths in the range 1529 to 1560 nm. The wavelength blocker 22 is controllable by a control signal, for example by an external control signal 21 received from the Network Controller NC (see FIG. 1). The control signal 21 comprises information concerning the optical wavelengths which are to be blocked (say, λ1,λ2) and/or the optical wavelengths which are allowed (say, λ3, λ4, λ5, etc.). According to the control signal 21, the wavelength blocker 22 blocks the wavelengths λ1,λ2. Optionally and preferably, the wavelength blocker 22 may perform dropping of the blocked wavelength(s) for further analyzing. FIG. 2 illustrates this option by showing power detectors 26 respectively switched in the dropped blocked optical channels. In case at least one of the detectors 26 detects power in excess of any predetermined reference or in excess of power measured in any other blocked channel, the fact is reported (arrows 27) to an external control entity (NC of FIG. 1). Since the reported fact may indicate that the blocked optical channel was probably attacked, the control entity may take suitable decisions and further regulate the WSOA 20 (by updating signal 21).

The non-blocked wavelengths (those assigned to allowed optical channels according to the proposed method) successfully pass through the wavelength blocker 22 and are then substantially evenly amplified by the EDFA amplifier 24. The amplified allowed channels are then ready to be transmitted to the network.

Additionally, the WSOA 20 may integrally accommodate a monitoring unit (circle 28) intended for monitoring the allowed (working) channels. The monitoring unit 28 can be positioned before or after the amplifier 24, it may even form a part of the block 22. Preferably, the monitoring unit 28 should be able to provide monitoring of each optical channel according to an accepted technology. The monitoring function with respect to particular working wavelengths required for the currently actual configuration can be enabled (activated) by an external control unit, by the same control signal which is used for controlling the block 22. (This signal is marked with an arrow 121).

For example, the monitoring unit 28 is based on measuring BER/OSNR or like parameters of the respective optical signals. In case the monitoring unit 28 detects that a specific working channel carries an abnormal signal from the point of BER/OSNR or the like, it issues at least one alarm signal (arrows 29), which can be transmitted to an external control unit (NC).

In one specific optional embodiment, the WSOA 20 comprises a local controller LC 30 (shown by a dotted contour), which may serve as a mediator between the WSOA and an external control unit such as the NC (see FIG. 1). The LC 30 will then perform the bidirectional communication with the external control unit (see a dotted arrow 21a), both for receiving the control signal for the wavelength blocker 22 (dotted arrow 21b, analogous to the arrow 21), and for reporting to the external control unit about abnormal events in various optical channels (thus performing the functions analogous to those indicated by arrows 27, 29). These events include non-typical values of physical parameters at the blocked channels and at the working channels; information about these events are collected by the local controller LC 30 via dotted arrows 27a and 29a and then reported to the external controller NC.

However, the local control unit 30 may have some autonomic functions. For example, based on the information collected from the monitoring unit 28 via connections (arrows) 29a, the LC 30 may make an urgent local decision to block one or more of the previously allowed working channels. This decision will then be sent to the WLB 22 via the already mentioned connection shown by dotted arrow 21b. Priorities between decisions of the local controller 30 and the external control unit (NC) should be preliminarily defined.

LC 30 can optionally control the monitoring unit 28 via a dotted line 21c for enabling/disabling monitoring of one or more specific wavelengths. This function is analogous to the control function (arrow 121) provided directly by the external controller.
However, if all possible wavelengths are monitored, the LC 30 may collect results of detecting optical signals from the power detectors 26 and results of monitoring optical signals from the monitoring unit 28; based on the collected information, the LC 30 may check whether the wavelength blocker 21 properly blocked all non-desired wavelengths.

It should be appreciated that the invention can be implemented on different configurations of the network, using different implementations of the WSOA and of the NC, an that any of such variations should be considered part of the invention whenever being covered by the claims which follow.

1-25. (canceled)

26. A method for managing a group of network nodes in a multi-channel optical communication network comprising a plurality of network nodes and a number of optical fiber links, wherein the group comprises at least one network node,
the method comprising:
at each specific network node of said group, providing at least one wavelength selective optical amplifier WSOA in at least one optical fiber link incoming the specific network node,
providing a network controller NC for holding and updating control information about optical channels allowed in said at least one optical fiber link incoming said at least one network node of the group, and for supplying each of said at least one wavelength selective amplifier WSOA with suitable control information concerning the incoming optical fiber link associated therewith;
at each of said at least one wavelength selective amplifier WSOA, in response to the control information received from the NC, blocking any wavelength incoming the WSOA from the incoming optical fiber link associated therewith, except for wavelengths assigned to the optical channels allowed in said incoming optical fiber link.

27. The method according to claim 26, comprising additional steps of:
determining whether one or more of the wavelengths, blocked by any of said WSOA, carry optical signals,
if in the affirmative, issuing an indication signal to the network controller NC.

28. The method according to claim 26, comprising additional steps of:
determining whether one or more of the wavelengths, allowed in the optical fiber links incoming the network nodes of said group, carry signals not satisfying one or more of predetermined criteria,
if in the affirmative, issuing an alarm signal to the network controller NC.

29. The method according to claim 26, further comprising a step of making a decision at said NC, that intrusion has been undertaken using one or more of the wavelengths transmittable via the optical fiber links incoming the network nodes of the group, and a step of initiating one or more security measures.

30. A network section in a multi-channel optical network comprising a plurality of network nodes and a number of optical fiber links, wherein the network section comprising:
a group of one or more network nodes, wherein at each specific network node of the group, at least one optical fiber link incoming the specific network node is provided with at least one wavelength selective optical amplifier WSOA,
a network controller NC for holding and updating control information about optical channels allowed in said at least one optical fiber link incoming said at least one network node of the group, and for supplying each of said at least one wavelength selective amplifier WSOA with suitable control information concerning the incoming optical fiber link associated therewith;
wherein each of said WSOA is controllable by said network controller NC so as to amplify only wavelengths assigned to the optical channels allowed in the incoming optic fiber link associated with said WSOA, while blocking any other wavelengths.

31. The network section according to claim 30, wherein the network controller NC holds topology data on at least said network section and, according to said topology data,
considers optical channels expected to pass via a specific optical fiber link to be allowed optical channels for that specific optical fiber link;
provides control of the WSOAs in the network section according to the topology data, by issuing respective control signals.

32. The network section according to claim 30, wherein at least one of said WSOAs is associated with at least one per-channel detector for determining, whether an optical signal is carried by any of the wavelengths blocked by said at least one WSOAs; in case the optical signal is detected, said detectors being adapted to provide a suitable indication signal to the network controller NC.

33. The network section according to claim 30, further provided with at least one monitoring unit associated with an optical fiber link of the network section for monitoring one or more optical channels in said link, the monitoring unit being capable of issuing an alarm signal if one or more traffic criteria are not satisfied in one or more of said optic channels.

34. A wavelength selective optical amplifier (WSOA) controllable by a control signal and intended to be connected, as an integrated component, in an optical fiber link;
the WSOA being adapted, when switched in the optical fiber link and controlled by the control signal, to selectively block one or more optical wavelengths among various optical wavelengths incoming said WSOA from the optical fiber link, while amplifying non-blocked wavelengths incoming said WSOA.

35. The WSOA according to claim 34, comprising one or more components selected from a list including: a wavelength selective blocker, a tunable filter, a wavelength selective switch, a selective attenuation array; said WSOA also comprising one or more amplifying components.

36. The WSOA according to claim 34, further comprising power detectors for detecting optical signals if carried by one or more wavelengths blocked by said WSOA, said WSOA being also operative to provide an indication signal to a control unit about wavelengths at which said optical signals are detected.

37. The WSOA according to claim 34, further comprising a monitoring unit for monitoring optical signals carried at least by the non-blocked wavelengths, operative to provide an alarm signal to a control unit whenever at least one of said optical signals do not satisfy one or more predetermined criteria.
